(19) United States
(12) Patent Application Publication
(10) Pub. No.: US 2010/0254822 A1
(43) Pub. Date: Oct. 7, 2010

(54) Super oxidation and cyclic damage resistant nickel-base superalloy and articles formed therefrom

(76) Inventors: Brian Thomas Hazel, West Chester, OH (US); Kevin Swayne O'Hara, Boxford, MA (US); Laura Jill Carroll, Ammon, ID (US)

Correspondence Address: GENERAL ELECTRIC COMPANY, GE AVIATION, ONE NEUMANN WAY MD F16, CINCINNATI, OH, 45215, US

(21) Appl. No.: 12/570,555

(22) Filed: Sep. 30, 2009

Related U.S. Application Data
(63) Continuation-in-part of application No. 12/409,929, filed on Mar. 24, 2009, now abandoned.

(51) Int. Cl. F03B 3/12; C22C 19/05

(52) U.S. Cl. 416/241 R; 420/445; 420/448; 420/443

(57) ABSTRACT

A nickel-base superalloy composition including (measured in % by weight) from about 6.5 to about 7.5% aluminum, from about 4 to about 8% tantalum, from about 3 to about 10% chromium, from about 2 to about 7% tungsten, from 0 to about 4% molybdenum, from 0 to about 6% rhenium, from 0 to less than about 0.001% niobium, from 0 to about 5% cobalt, from 0 to about 0.2% silicon, from 0 to about 0.06% carbon, optionally, from 0 to about 0.5% titanium, from 0 to about 0.005% boron, from about 0.15 to about 0.7% hafnium, from 0 to about 0.03% of a rare earth addition selected from the group consisting of yttrium, lanthanum, cesium, and combinations thereof, balance nickel and incidental impurities. The nickel-base superalloy composition may be used in single-crystal or directionally solidified superalloy articles such as high pressure turbine blades for a gas turbine engine.

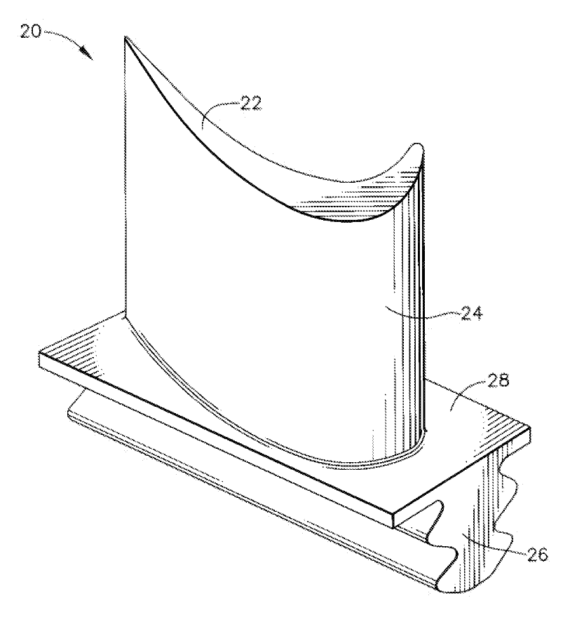

### CROSS REFERENCE TO RELATED APPLICATIONS

This application is a Continuation-in-Part Application of co-pending U.S. patent application Ser. No. 12/409,929 filed Mar. 24, 2009, which is incorporated herein in its entirety.

### BACKGROUND OF THE INVENTION

This invention relates generally to compositions of matter suitable for use in aggressive, high-temperature gas turbine environments, and articles made therefrom.

Nickel-base single crystal superalloys are used extensively throughout the aeroengine in turbine blade, nozzle, and shroud applications. Aeroengine designs for improved engine performance demand alloys with increasingly higher temperature capability, primarily in the form of improved creep strength (creep resistance). Alloys with increased amounts of solid solution strengthening elements (e.g., Ta, W, Re, and Mo) for improved creep resistance generally exhibit decreased phase stability, increased density, and lower environmental resistance. Recently, thermal-mechanical fatigue (TMF) resistance has been a limiting design criterion for turbine components. Temperature gradients create cyclic thermally induced strains that promote damage by a complex combination of creep, fatigue, and oxidation. Directionally solidified superalloys have not historically been developed for cyclic damage resistance. However, increased cyclic damage resistance is desired for improved engine efficiency.

Single crystal (SX) superalloys may be classified into four generations based on similarities in alloy compositions and high temperature mechanical properties. So-called first generation single crystal superalloys contain no rhenium. Second generation superalloys typically contain about three weight percent rhenium. Third generation superalloys are designed to increase the temperature capability and creep resistance by raising the refractory metal content and lowering the chromium level. Exemplary alloys have rhenium levels of about 5.5 weight percent and chromium levels in the 2-4 weight percent range. A commercially available fourth generation alloy includes increased levels of rhenium and other refractory metals.

Second generation alloys are not exceptionally strong, although they have relatively stable microstructures. Oxidation resistance is achieved in second generation alloys with yttrium additions or low sulfur content. Third and fourth generation alloys have improved creep resistance due to high levels of refractory metals in the alloy. In particular, high levels of tungsten, rhenium, and ruthenium are used for strengthening these alloys. These refractory metals have densities much higher than that of the nickel base.

The addition of these refractory metals impacts the overall alloy density, such that fourth generation alloys may be about 6% heavier than second generation alloys. The increased weight of these alloys limits their use to only specialized applications. Third and fourth generation alloys are also limited by microstructural instabilities which can impact long-term mechanical properties.

Each subsequent generation of alloys was developed in an effort to improve the creep strength and temperature capability of the prior generation. For example, third generation superalloys provide a 50° F. (about 28° C.) improvement in creep capability relative to second generation superalloys. Fourth and fifth generation superalloys offer a further improvement in creep strength achieved by high levels of solid solutioning elements (e.g., rhenium, tungsten, tantalum, molybdenum) and the addition of ruthenium. As the creep capability of directionally solidified superalloys has improved with generation, the continuous-cycle fatigue resistance, as well as the hold-time cyclic damage resistance, have also improved. These improvements in rupture and fatigue strength have been accompanied by an increase in alloy density. There is a microstructural and environmental penalty for continuing to increase the amount of refractory elements in directionally solidified superalloys. For example, third generation superalloys are less stable with respect to topological close-packed phases (TCP) and tend to form a secondary reaction zone (SRZ). The lower levels of chromium, necessary to maintain sufficient microstructural stability, results in decreased environmental resistance in the subsequent generations of superalloys. Cyclic damage resistance is quantified by SPLCF (sustained-peak or hold time low cycle fatigue) testing. Despite the lower oxidation resistance of 3^{rd} and 4^{th} generation superalloys (relative to 2^{nd} generation), the SPLCF resistance improved, likely driven by the higher creep strengths.

Although the exact mechanism by which cyclic damage accumulates in single crystal superalloys is not well understood, oxidation kinetics appears to play a role in crack propagation. Accordingly, it would be desirable to provide an oxidation resistant, lower density superalloy composition with greater cyclic damage resistance and improved microstructure stability.

### BRIEF DESCRIPTION OF THE INVENTION

The above-mentioned need or needs may be met by exemplary embodiments which provide a composition of matter consisting essentially of, in weight percent, from about 6.5 to about 7.5% aluminum, from about 4 to about 8% tantalum, from about 3 to about 10% chromium, from about 2 to about 7% tungsten, from 0 to about 4% molybdenum, from 0 to about 6% rhenium, from 0 to less than about 0.001% niobium, from 0 to about 5% cobalt, from 0 to about 0.2% silicon, from 0 to about 0.06% carbon, optionally, from 0 to about 0.5% titanium, from 0 to about 0.005% boron, from about 0.15 to about 0.7% hathium, from 0 to about 0.03% of a rare earth addition selected from the group consisting of yttrium, lanthanum, cesium, and combinations thereof, balance nickel and incidental impurities.

In another embodiment, there is provided a composition of matter consisting essentially of, in weight percent, from about 6.6 to about 7.1% aluminum, from about 4 to about 6.5% tantalum, from about 7 to about 8% chromium, from about 3.5 to about 4.5% tungsten, from 0 to about 1% molybdenum, from 1.5 to about 3.5% rhenium, up to about 5% cobalt, up to about 0.2% silicon, up to about 0.03% carbon, optionally, from 0 to less than about 0.001% niobium, from 0 to about 0.5% titanium, from 0 to about 0.005% boron, from about 0.15 to about 0.7% hafnium, from 0 to about 0.03% of a rare earth addition selected from the group consisting of yttrium, lanthanum, cesium, and combinations thereof, balance nickel and incidental impurities.

Exemplary embodiments disclosed herein include an article comprising a substantially single crystal having a composition consisting essentially of, in weight percent, from about 6.5 to about 7.5% aluminum, from about 4 to about 8% tantalum, from about 3 to about 10% chromium, from about 2 to about 7% tungsten, from 0 to about 4% molybdenum, from 0 to about 6% rhenium, from 0 to less than about 0.001% niobium, from 0 to about 5% cobalt, from 0 to about 0.2% silicon, from 0 to about 0.06% carbon, optionally, from 0 to about 0.5% titanium, from 0 to about 0.005% boron, from about 0.15 to about 0.7% hathium, from 0 to about 0.03% of a rare earth addition selected from the group consisting of yttrium, lanthanum, cesium, and combinations thereof, balance nickel and incidental impurities.

### BRIEF DESCRIPTION OF THE DRAWINGS

The subject matter which is regarded as the invention is particularly pointed out and distinctly claimed in the concluding part of the specification. The invention, however, may be best understood by reference to the following description taken in conjunction with the accompanying drawing figures in which:

The FIGURE is a perspective view of a component article such as a gas turbine blade.

### DETAILED DESCRIPTION OF THE INVENTION

Referring to the drawings, the FIGURE depicts a component article 20 of a gas turbine engine, illustrated as a gas turbine blade 22. The gas turbine blade 22 includes an airfoil 24, an attachment 26 in the form of a dovetail to attach the gas turbine blade 22 to a turbine disk (not shown), and a laterally extending platform 28 intermediate the airfoil 24 and the attachment 26.

In an exemplary embodiment, the component article 20 is substantially a single crystal. That is, the component article 20 is at least about 80 percent by volume, and more preferably at least about 95 percent by volume, a single grain with a single crystallographic orientation. There may be minor volume fractions of other crystallographic orientations and also regions separated by low-angle boundaries. The single-crystal structure is prepared by the directional solidification of an alloy composition, usually from a seed or other structure that induces the growth of the single crystal and single grain orientation.

The use of exemplary alloy compositions discussed herein is not limited to the gas turbine blade 22, and it may be employed in other articles such as gas turbine nozzles, vanes, shrouds, or other components for gas turbine engines.

Certain embodiments disclosed herein are super-oxidation resistant nickel-base superalloy compositions designed specifically for sustained-peak low cycle fatigue (SPLCF) resistance, while exhibiting densities more akin to first generation alloys.

It is believed that the super-oxidation resistance of the disclosed alloys is a key factor in providing the uncharacteristically good SPLCF resistance. Thus, it is believed that the exemplary embodiments disclosed herein provide a unique alloying approach, that is, alloying for exceptional oxidation capability in order to provide improved SPLCF resistant alloys. An exemplary compositional series is presented in Table 1. Table II provides exemplary weight percent ranges for alloying elements.

Exemplary embodiments disclosed herein include a minimum of about 6.5% aluminum. Greater amounts result in improved oxidation resistance and SLCF resistance. Certain exemplary embodiments disclosed herein include from about 6.5 to about 7.5 wt % aluminum. Other exemplary embodiments include from about 6.5 to about 7.3 wt % aluminum. Other embodiments may include from about 6.7 to about 7 wt % aluminum. Percentages disclosed herein refer to percent by weight, unless otherwise noted. All amounts provided as ranges, for each element, should be construed to include endpoints and sub-ranges. For example, an aluminum range of from about 6.5 to about 7.5wt % means that the exemplary embodiments may include about 6.5 wt % aluminum, about 7.5 wt % aluminum, any amount of aluminum between 6.8 and 7.5 wt %, and any range of aluminum between 6.8 and 7.5 wt %, inclusive.

Exemplary embodiments disclosed herein include about 4 to 8 wt % tantalum to promote gamma prime strength. Exemplary embodiments may include from about 5 to about 7 wt % tantalum.

Exemplary embodiments disclosed herein include from about 3 to about 10 wt % chromium to reduce hot corrosion resistance. It is believed that amounts greater than about 10% lead to TCP phase instability and poor cyclic oxidation resistance. Other exemplary embodiments may include from about 3 to about 10 wt % chromium. Exemplary embodiments may include from about 4 to about 8 wt % chromium. Exemplary embodiments disclosed herein may include from about 7 to about 7.5 wt % chromium.

Exemplary embodiments disclosed may herein include tungsten in amounts from about 2 to about 7 wt %. Other exemplary embodiments may include tungsten in amounts from about 3.5 to about 4.5 wt %. Other exemplary embodiments may include tungsten in amounts from about 3 to about 7 wt %. Amounts less than about 2% tungsten may decrease strength. Amounts greater than about 7% may produce alloy instability with respect to TCP phase formation and reduced oxidation capacity. Tungsten may also be used as a strengthener in place of rhenium.

Exemplary embodiments disclosed herein optionally include molybdenum in amounts limited from about 0 to 4 wt % maximum. In some exemplary embodiments, if present, the amount of molybdenum does not exceed about 3 wt %. Other exemplary embodiments include molybdenum in amounts from about 0.01 to about 0.05 wt %. Molybdenum may be minimally present to impart solid solution strengthening. Higher additions of molybdenum result in reduced hot corrosion resistance.

Exemplary embodiments disclosed herein may include rhenium in the range of from 0 to about 4 wt % for high temperature creep resistance. Other exemplary embodiments may include rhenium at levels between about 1.5 to about 3.5 wt %. Certain exemplary embodiments include rhenium in amounts up to about 3.3 wt %. Rhenium is a potent solid solution strengthener that partitions to the gamma phase and also is a slow diffusing element, which limits coarsening of the gamma prime.

Exemplary embodiments generally include less than 0.001 wt % niobium as an intentional alloying element.

Exemplary embodiments disclosed herein may include up to about 5 wt % cobalt. Other exemplary embodiments may include from about 2.5 to about 3.5 wt % cobalt.

Exemplary embodiments disclosed herein may optionally include silicon additions of up to about 0.2 wt % for improved oxidation resistance.

Exemplary embodiments disclosed herein may optionally include from about 0.15 wt % to about 0.7 wt % hafnium. Hafnium improves the oxidation and hot corrosion resistance of coated alloys, but can degrade the corrosion resistance of uncoated alloys. Hafnium also improves the life of thermal barrier coatings where used. Experience has shown that hafnium contents on the order of 0.7 wt % are satisfactory. However, when the hafnium content exceeds about 1%, stress rupture properties are reduced along with the incipient melting temperature.

Exemplary embodiments disclosed herein may further optionally include rare earth additions of yttrium, lanthanum and cerium, singly or in combination, up to about to 0.03 wt %. These additions may improve the oxidation resistance by making the protective alumina scale more retentive. Greater amounts promote mold-metal reaction at the casting surface and increase the component inclusion content.

Exemplary embodiments disclosed herein may optionally include carbon additions up to about 0.06 wt %. A preferred range of carbon is about 0.02% to about 0.06%. The lower level is set in order to improve the alloy cleanliness since carbon provides de-oxidation. Beyond the 0.06 wt % carbon amount, the carbide volume fraction increases and fatigue life is reduced since carbides serve as the sites for fatigue nucleation.

Exemplary embodiments disclosed herein may optionally include boron additions up to about 0.005 wt %. Boron provides tolerance for low angle boundaries.

Exemplary embodiments disclosed herein may optionally include up to about 0.5 wt % titanium as a potent gamma prime hardener.

The thermal-mechanical fatigue resistance of nickel-base superalloys has traditionally been considered as functionally related to strength. Exemplary embodiments disclosed herein demonstrate that thermal-mechanical fatigue resistance, specifically sustained-peak low cycle fatigue resistance (SPLCF), may be improved by alloying to increase oxidation resistance. Thus, the super-oxidation resistant alloys disclosed herein provide the desired thermal-mechanical fatigue resistance. Further, the disclosed embodiments demonstrate a method for improving the thermal-mechanical properties of a nickel-base superalloy by alloy additions for super-oxidation resistance.

TABLE I
Experimental target alloy compositions

| | Alloy | | | | | | | | | | | | |
|---|---|---|---|---|---|---|---|---|---|---|---|---|---|
| | Al | Ta | Cr | W | Mo | Re | Nb | Co | Si | Hf | Y | C | B |
| Comparative | 6.2 | 6.5 | 7 | 5 | 1.5 | 3 | 0 | 7.5 | 0 | 0.15 | 0.01 | 0.05 | .004 |
| Alloy | | | | | | | | | | | | | |
| (Rene' N5) | | | | | | | | | | | | | |
| 1 | 6.7 | 5.2 | 7.4 | 3.6 | 0.04 | 1.6 | <.001 | 2.9 | 0.1 | * | * | 0.02 | * |
| 2 | 7.1 | 5.3 | 7.4 | 3.8 | 0.01 | 1.6 | <.001 | 3.0 | 0.1 | * | * | 0.02 | * |
| 9 | 6.6 | 6.2 | 7.3 | 3.9 | 0.01 | 1.7 | <.001 | 3.1 | .01 | * | * | 0.02 | * |
| 11 | 6.6 | 4.5 | 7.2 | 3.8 | 0.05 | 1.7 | <.001 | 3.1 | 0.1 | * | * | 0.02 | * |
| 12 | 7.0 | 4.4 | 7.4 | 4.0 | 0.01 | 1.8 | <.001 | 3.1 | 0.1 | * | * | 0.02 | * |
| 13 | 6.6 | 4.5 | 7.3 | 4.1 | 0.01 | 3.3 | <.001 | 2.9 | 0.1 | * | * | 0.02 | * |
| 14 | 7.0 | 5.4 | 7.2 | 4.0 | 0.01 | 3.3 | <.001 | 2.9 | 0.1 | * | * | 0.02 | * |
| 15 | 6.6 | 6.4 | 7.2 | 4.0 | 0.01 | 3.3 | <.001 | 2.9 | 0.1 | * | * | 0.02 | * |
| 16 | 7.0 | 6.1 | 7.4 | 3.8 | 0.00 | 3.1 | 0 | 3.0 | 0.04 | * | * | 0.02 | * |
| 17 | 6.6 | 4.5 | 7.4 | 3.7 | 0.02 | 3.0 | <.001 | 2.8 | 0.1 | * | * | 0.02 | * |
| 18 | 7.0 | 4.4 | 7.5 | 3.8 | 0.01 | 3.1 | <.001 | 2.8 | 0.1 | * | * | 0.02 | * |

% by weight, balance Nickel and incidental impurities.
* Optional additions: From about 0.15 to about 0.7% Hf, up to about 0.5% Ti, up to about 0.005% B; Rare Earth additions (i.e., Y, La, Ce) up to about 0.03%,

TABLE II
Exemplary Elemental Ranges in Weight Percent

| | Alloy | | | | | | | | | | | | |
|---|---|---|---|---|---|---|---|---|---|---|---|---|---|
| | Al | Ta | Cr | W | Mo | Re | Nb | Co | Si | Hf | Y | C | B |
| Min. | 6.5 | 4 | 3 | 2 | 0 | 0 | 0 | 0 | 0 | * | * | 0.02 | * |
| wt % | | | | | | | | | | | | | |
| Max. | 7.5 | 8 | 10 | 7 | 4 | 4 | <.001 | 5 | 0.2 | * | * | 0.06 | * |
| wt % | | | | | | | | | | | | | |

Balance Nickel and incidental impurities.
* Optional additions: If present, Hf from about 0.15 to about 0.7%; up to about 0.5% Ti, up to about 0.005% B; Rare Earth (i.e., Y, La, Ce) up to about 0.03%.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A composition of matter consisting essentially of, in weight percent, from about 6.5 to about 7.5% aluminum, from about 4 to about 8% tantalum, from about 3 to about 10% chromium, from about 2 to about 7% tungsten, from 0 to about 4% molybdenum, from 0 to about 6% rhenium, from 0 to less than about 0.001% niobium, from 0 to about 5% cobalt, from 0 to about 0.2% silicon, from 0 to about 0.06% carbon, optionally, from 0 to about 0.5% titanium, from 0 to about 0.005% boron, from about 0.15 to about 0.7% hafnium, from 0 to about 0.03% of a rare earth addition selected from the group consisting of yttrium, lanthanum, cesium, and combinations thereof, balance nickel and incidental impurities.

2. The composition of matter according to claim 1 wherein aluminum is present in amounts from about 6.5 to about 7.3 wt %.

3. The composition of matter according to claim 1 wherein rhenium, if present, does not exceed about 3.3 wt %.

4. The composition of matter according to claim 1 wherein chromium is present in amounts from about 4 to about 8 wt %.

5. The composition of matter according to claim 1 wherein molybdenum, if present, does not exceed about 3 wt %.

6. The composition of matter according to claim 1 wherein tungsten is present in amounts from about 3 to about 7 wt %.

7. The composition of matter according to claim 1 wherein tantalum is present in amounts from about 5 to about 7 wt %.

8. A composition of matter consisting essentially of, in weight percent, from about 6.6 to about 7.1% aluminum, from about 4 to about 6.5% tantalum, from about 6 to about 8% chromium, from about 3.5 to about 5.5% tungsten, from 0 to about 1% molybdenum, from 1.5 to about 3.5% rhenium, up to about 5% cobalt, up to about 0.2% silicon, up to about 0.03% carbon, optionally, from 0 to less than about 0.001% niobium, from 0 to about 0.5% titanium, from 0 to about 0.005% boron, from about 0.15 to about 0.7% hafnium, from 0 to about 0.03% of a rare earth addition selected from the group consisting of yttrium, lanthanum, cesium, and combinations thereof, balance nickel and incidental impurities.

9. The composition of matter according to claim 8 wherein aluminum is present in amounts from about 6.7 to about 7 wt %.

10. The composition of matter according to claim 8 wherein rhenium is present in amounts from about 1.5 to about 3.3 wt %.

11. The composition of matter according to claim 6 wherein chromium is present in amounts from about 5 to about 7.5 wt %.

12. An article comprising a substantially single crystal having a composition consisting essentially of, in weight percent, from about 6.5 to about 7.5% aluminum, from about 4 to about 8% tantalum, from about 3 to about 10% chromium, from about 2 to about 7% tungsten, from 0 to about 4% molybdenum, from 0 to about 6% rhenium, from 0 to less than about 0.001% niobium, from 0 to about 5% cobalt, from 0 to about 0.2% silicon, from 0 to about 0.06% carbon, optionally, from 0 to about 0.5% titanium, from 0 to about 0.005% boron, from about 0.15 to about 0.7% hathium, from 0 to about 0.03% of a rare earth addition selected from the group consisting of yttrium, lanthanum, cesium, and combinations thereof, balance nickel and incidental impurities.

13. The article according to claim 12 comprising a blade of a gas turbine.

14. The article according to claim 12 comprising a component of a gas turbine engine selected from a nozzle, a shroud, a splash plate, and a combustor component.

15. The article according to claim 11 comprising a directionally solidified component.
